(19) United States
(12) Patent Application Publication
(10) Pub. No.: US 2006/0174307 A1
(43) Pub. Date: Aug. 3, 2006

(54) Broadcast terminal and method for multi-tasking

(75) Inventors: Su-Yeon Hwang, Gyeonggi-Do (KR); Bo-Hui Choi, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5354, US

(73) Assignee: LG Electronics Inc.

(21) Appl. No.: 11/285,494

(22) Filed: Nov. 21, 2005

(30) Foreign Application Priority Data
Nov. 22, 2004 (KR) 95950/2004

(51) Int. Cl. H04N 7/18; H04N 7/173; H04N 7/16

(52) U.S. Cl. 725/132; 725/100; 725/131; 725/151; 725/140; 725/152; 725/80; 725/81

(57) ABSTRACT

A broadcast terminal and method for multitasking are disclosed. The broadcast terminal for multitasking includes a module unit for executing a plurality of tasks; a multitask unit for managing a plurality of executed tasks as a first task group and a second task group; a controller for providing a control signal based on the managed first and second task groups; and a virtual output unit for virtually executing tasks belonging to the second task group according to the control signal.

### CROSS-REFERENCE TO RELATED APPLICATIONS

Pursuant to 35 U.S.C. § 119(a), this application claims the benefit of the Korean Patent Application No. 95950/2004, filed on Nov. 22, 2004, which is hereby incorporated by reference as if fully set forth herein.

### FIELD OF THE INVENTION

The present invention relates to a mobile communication terminal and, more particularly, to a broadcast terminal and method for multitasking capable of performing several tasks at one time.

### BACKGROUND OF THE INVENTION

In general, a mobile communication terminal is a device with which a user can wirelessly page another party and be wirelessly connected for communication any time and anywhere. This can be achieved by controlling the switching by a mobile switching center (MSC) while traveling in a service area managed by a base station (BS), and allows data communication of symbols, numbers or characters and multimedia communication including an image signal, as well as voice communication.

Recently, mobile communication terminals, such as a broadcast terminal, a Personal Digital Assistant (PDA) terminal, a “smart” terminal, or the like, providing diverse functions have been developed, and among them, especially, the various broadcast terminals which can support digital multimedia broadcasting having audio, video, and data services are being actively developed.

An exemplary digital multimedia broadcast terminal will now be explained. A system implementing digital multimedia broadcasting through the terminal can be divided into a terrestrial (ground wave) system transmitting broadcast content from a ground antenna and a satellite system transmitting broadcast content from a satellite.

The construction of the terrestrial digital multimedia broadcasting system in accordance with related art will now be described with reference to FIG. 1, wherein a related art terrestrial system includes: a broadcasting center 200 for wirelessly transmitting broadcast content provided by a service provider 600 through a public network 400; a first terminal 100 for receiving the wirelessly transmitted broadcast content; a server 300 for transmitting the broadcast content provided through the public network 400 from the service provider 600, using a fixed line; a second terminal 500 for receiving the broadcast content transmitted through the fixed line. Here, the first terminal 100 refers to a terminal that can receive the broadcast content wirelessly and the second terminal 500 refers to a terminal that can receive the broadcast through a fixed line.

The method for receiving the broadcast content by the terminal will now be described with reference to FIG. 2, wherein FIG. 2 is a flow chart illustrating the processes of a method for receiving broadcast content by the terminal in accordance with the related art. As shown in FIG. 2, the method for receiving broadcast content by the terminal includes: checking whether to receive broadcast content selected by a user (step S210); receiving and displaying the broadcast content (step S220); checking whether a supplementary service is selected by the user while the broadcast content are being displayed (step S230); stopping the receipt of the broadcast content when a supplementary service is selected by the user, and executing the selected supplementary service (step S240); and checking whether the executed supplementary service is terminated (step S250).

The step of executing the selected supplementary service (step S240) further includes: terminating the displayed broadcast content (step S242); and executing the supplementary service selected by the user (step S244).

The related art method for receiving the broadcast content by the terminal will be described in detail as follows.

First, the first terminal 100 receives broadcast guide information through the broadcasting center 200, which wirelessly forwards broadcast content provided through the public network 400 from the service provider 600, and displays the received broadcast guide information on a display unit suitable to a user environment, thereby enabling the user to select desired broadcast content and to receive the selected broadcast content through a forwarding channel (step S210).

The first terminal 100 receives the selected broadcast content and displays it on the display unit, for example, a liquid crystal display (LCD) (step S220).

While the broadcast content is being displayed, the first terminal checks whether the user selects a supplementary service (step S230). When the user selects a supplementary service, the receiving of the broadcast content is interrupted and the selected supplementary service is executed (step S240). Namely, the first terminal 100 terminates the displayed broadcast content (step S242) and subsequently executes the selected supplementary service (step S244).

Thereafter, the first terminal 100 checks whether the selected supplementary service is terminated (step S260). When the selected supplementary service is terminated, the first terminal 100 can receive and display the broadcast content according to user selection.

Meanwhile, the second terminal 500 receives broadcast guide information through the server 300, which wirelessly forwards broadcast content provided through the public network 400 from the service provider 600, and displays the received broadcast guide information on the display unit suitable to the user environment, so that the user can select desired broadcast content and receive it through the forwarding channel.

As mentioned above, the related art method for receiving the broadcast content by the terminal has the problem that when the user selects a supplementary service while receiving the broadcast content, the user stops receiving of the broadcast content and then executes the selected supplementary service, so the process for receiving the broadcast content must be set again by the user after the executed supplementary service is terminated.

### SUMMARY OF THE INVENTION

Therefore, an object of the present invention is to provide a broadcast terminal for multitasking and method thereof capable of executing a plurality of tasks simultaneously. The terminal classifies a plurality of tasks executed according to user selection into a first task group having an activated task, and into a second task group having a deactivated task, and managing the tasks separately.

To achieve at least the above objects in whole or in part, a broadcast terminal is provided for multitasking including: a module unit for executing a plurality of tasks; a multitask unit for managing a plurality of executed tasks as a first task group and a second task group; a controller for providing a control signal based on the managed first and second task groups; and a virtual output unit for virtually performing tasks belonging to the second task group according to the control signal.

To achieve at least these advantages in whole or in part, a method is further provided for multitasking of a broadcast terminal including: checking whether a second task is selected by a user while a first task is being executed; deactivating the first task when the second task is selected, and activating the second task; checking whether the activate second task is terminated; and re-activating the first task when the second task is terminated.

To achieve at least the above objects in whole or in part, an apparatus is provided for supporting digital multimedia broadcasting including: a module unit to store instructions used to perform multiple tasks; a multitask unit to manage the multiple tasks to be performed; and a controller cooperating with the module unit and the multitask unit to execute a first task and detect whether a second task is selected while the first task is being executed, temporarily deactivating the first task when the second task is selected and activated, and re-activating the first task when the second task is terminated.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The invention will be described in detail with reference to the following drawings in which like reference numerals refer to like elements wherein:

FIG. 1 is a schematic view showing the construction of a terrestrial system in accordance with a related art;

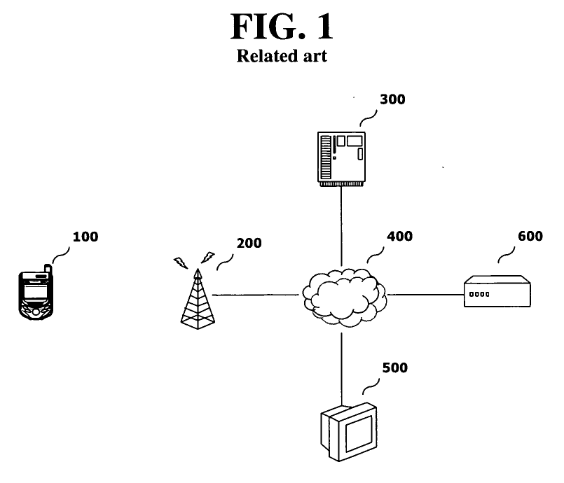

FIG. 2 is a flow chart illustrating the processes of a method for receiving broadcast content by a terminal;

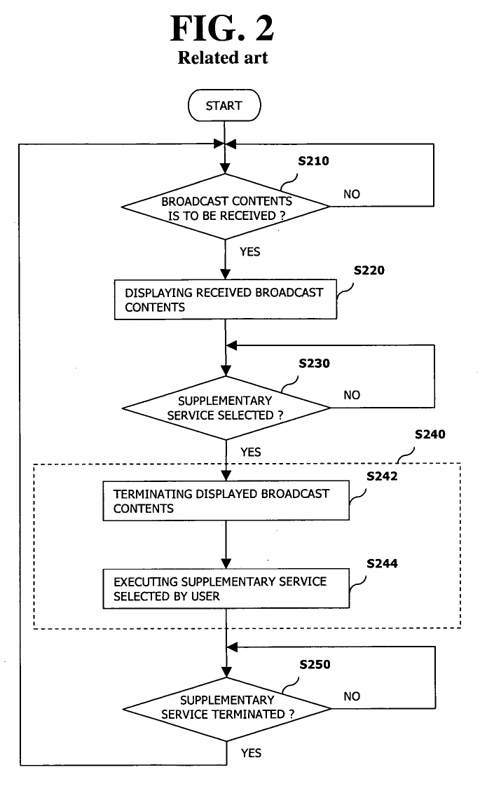

FIG. 3 is a block diagram showing the construction of an exemplary broadcast terminal for multitasking in accordance with the present invention; and

FIG. 4 is a flow chart illustrating processes of an exemplary method for multitasking of the broadcast terminal in accordance with the present invention.

### DETAILED DESCRIPTION OF THE EMBODIMENTS

A broadcast terminal for multitasking and method thereof capable of executing a plurality of tasks simultaneously by classifying a plurality of tasks, executed according to user selection, into a first task group having an activated task and a second task group having a deactivated task, and separately managing them, in accordance with the present invention will now be described with reference to the accompanying drawings. The broadcast terminal according to the present invention can be applied to a digital multimedia broadcasting system, and further applied to any system such as Digital Multimedia Broadcasting (DMB), Digital Video Broadcasting Handheld (DVB-H), Media-Forward link only (Media-Flo), and the like.

Multitasking is not limited in its meaning to dependence on or supplementation to a task, but refers to simultaneously executing a plurality of individual tasks each with an equal level. For example, the executed task may be: (1) online services such as online games, mobile Internet services, a Video On Demand (VOD) function and a file downloading function; (2) various messaging functions such as chatting, instant messaging, text messaging, multimedia messaging, e-mail functions; (3) a call function such as a voice call or a video call; (4) a camera function such as taking videos or still images; and (5) various supplementary functions such as a scheduler, phone book searching, a calculator, memorandum, recording of call content, setting of a terminal state, calendar searching, displaying of world time, alarm setting, reproducing of video or music files.

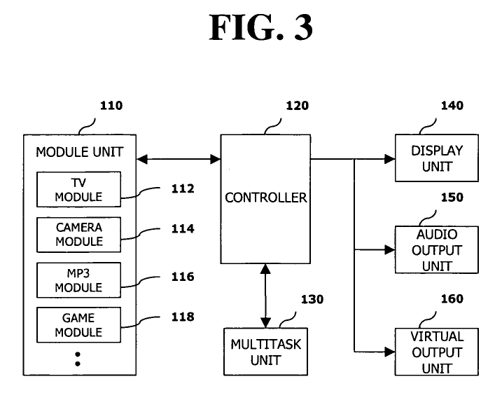

FIG. 3 is a block diagram showing the construction of an exemplary broadcast terminal for multitasking in accordance with the present invention, wherein the broadcast terminal for multitasking may include: a controller 120 for providing a control signal used for controlling a plurality of tasks selected by a user; a module unit 110 for separately executing the plurality of tasks based on the control signal; a multitask unit 130 for classifying the plurality of executed tasks into a first task group having activated tasks and a second task group having a deactivated tasks, and managing them; a virtual output unit 160 for virtually performing tasks belonging to the second task group; a display unit 140 for displaying a video signal of a task belonging to the first task group; and an audio output unit 150 for providing an audio signal of a task belonging to the first task group.

Preferably, the module unit 110 comprises at least one independent software module, at least one independent hardware module such as a TV module 112, for receiving the broadcast content, an MP3 module 114 for playing an MP3 music file, a camera module 116 for taking an image, a game module 118 for executing games, and the like.

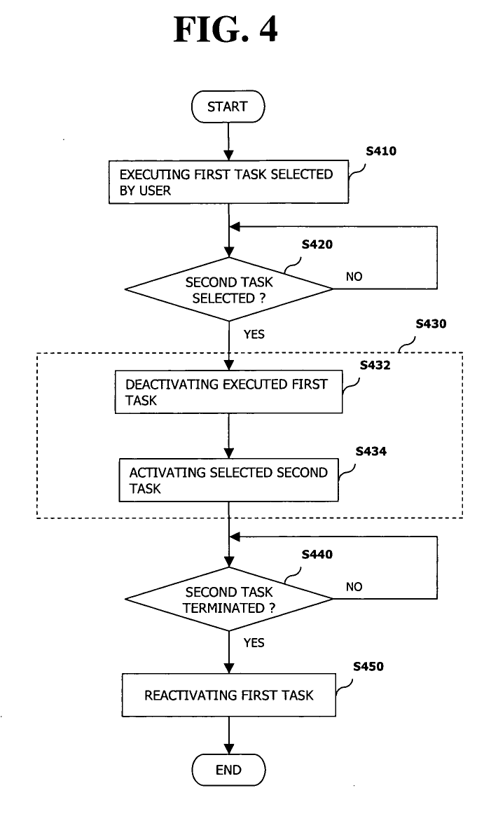

The method for multitasking of the broadcast terminal in accordance with the present invention will now be described with reference to FIG. 4. FIG. 4 is a flow chart illustrating processes of an exemplary method for multitasking of the broadcast terminal in accordance with the present invention.

As shown in FIG. 4, the method for multitasking of the broadcast terminal may include: executing a first task selected by a user (step S410); checking whether a second task is selected by the user while the first task is being executed (step S420); deactivating the first task when the second task is selected, and activating the second task (step S430); checking whether the activated second task is terminated (step S440); and re-activating the first task when the second task is terminated (step S450).

The step of activating the second task may include: changing the first task from the first task group to the second task group and deactivating it (step S432); and classifying the second task into the first task group and activating it (step S434).

An exemplary method for supporting the multitasking of the broadcast terminal in accordance with the present invention will be described in detail as follows.

First, the broadcast terminal executes the first task selected by the user (step S410). The controller 120 informs the multitask unit 130 that the first task has been selected, and the multitask unit 130 can classify the first task as the first task group and can inform the controller 120 of the classification result.

The controller 120 provides a control signal used for executing the selected first task to the module unit 110, and then, the module unit 110 can activate a module corresponding to the first task.

The controller 120 can display the first task selected through the driven module on the display unit 140, so that the user can process the first task. Namely, the controller 120 can display a video signal of the first task through the display unit 140 and can provide an audio signal of the first task through the audio output unit 150.

Thereafter, the controller 120 can check whether the second task is selected by the user (step S420). Namely, when the second task is selected, the controller 120 can inform the multitask unit 130 that the second task has been selected, and the multitask unit 130 can deactivate the first task and can activate the second task.

The multitask unit 130 can change the first task from the first group to the second group to deactivate the first task (step S432) and can classify the second task into the first task group to activate the second task (step S434).

The controller 120 can provide a control signal used for executing the selected second task to the module unit 110, and the module unit 110 can activate a module corresponding to the second task.

Consequently, the controller 120 can provide data related to the first task to the virtual output unit 160, so that not only the second task can be displayed on the display unit 140 through activating the module but also the first task can be continuously performed virtually without being interrupted while the second task is being executed.

Thereafter, the controller 120 can check whether the second task is terminated (step S440), and when the second task is terminated, the controller can re-activate the first task (step S450). Namely, the controller 120 can inform the multitask unit 130 that the second task has been terminated and the multitask unit 130 can change the first task to the first task group and activates the first task.

For example, the broadcast terminal receives broadcast content, and when the received broadcast content is displayed, the controller classifies receiving the broadcast content as the first task group.

The controller can check whether a user selects a supplementary service. For example, when the user selects a short message service (SMS) to transmit a short message, the controller 120 informs the multitask unit 130 that the short message service has been selected.

Then, the multitask unit 130 changes receiving the broadcast content from the first task group to the second task group, classifies the short message service as the first task group and informs the controller 120 of the classification result. Accordingly, the controller 120 deactivates receiving the broadcast content and activates the short message service.

At this time, because the short message service does not use the audio output unit, the audio signal of the broadcast content is provided through the audio output unit 150, enabling the user to listen to the audio signal of the broadcast content as well as to use the short message service.

Thereafter, the controller checks whether the user terminates the short message service. When the short message service is terminated, the controller changes receiving the broadcast content from the second task group to the first task group, so that a video signal of the broadcast content can be displayed through the display unit 140 and the audio signal of the broadcast content can be continuously provided to the audio output unit 150.

The present invention provides an apparatus for supporting digital multimedia broadcasting, the apparatus comprising: a module unit to store instructions used to perform multiple tasks; a multitask unit to manage the multiple tasks to be performed; and a controller cooperating with the module unit and the multitask unit to execute a first task and detect whether a second task is selected while the first task is being executed, temporarily deactivating the first task when the second task is selected and activated, and re-activating the first task when the second task is terminated.

The present invention may further comprise a plurality of output means, each used to provide audible, visual, or tactile outputs, respectively. The controller can selectively activate and deactivate the first task and the second task for providing an output to a single output means. Also, another task provides another type of output may be executed while the first task or the second task is being executed. For example, the first task can be an image reproduction function and the second task can be a short messaging service function. Furthermore, an audio reproduction function can be performed while the short messaging service function is being performed.

As so far described, the broadcast terminal for multitasking and method thereof in accordance with the present invention have the following advantages. That is, for example, by classifying the plurality of tasks executed according to user selection into the first task group having an activated task and the second task group having a deactivated task and managing them, a plurality of tasks can be simultaneously executed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

I claim:

1. A broadcast terminal for multitasking, the terminal comprising:
a module unit for executing a plurality of tasks;
a multitask unit for managing a plurality of executed tasks as a first task group and a second task group;
a controller for providing a control signal based on the managed first and second task groups; and
a virtual output unit for executing tasks belonging to the second task group according to the control signal,
wherein the controller cooperating with the module unit and the multitask unit for executing a task of the first task group and detecting whether a task of the second task group is selected while the task of the first task group is being executed, deactivating the task of the first task group when the task of the second task group is selected, activating the task of the second task group, and re-activating the task of the first task group when the task of the second task group is completed

2. The terminal of claim 1, further comprising:
a display unit for displaying a video signal of a task belonging to the first task group; and
an audio output unit for providing an audio signal of a task belonging to the first task group.

3. The terminal of claim 1, wherein the first task group comprises an activated task among the plurality of executed tasks.

4. The terminal of claim 1, wherein the second task group comprises a deactivated task among the plurality of executed tasks.

5. The terminal of claim 1, wherein the module unit comprises at least one independent software module.

6. The terminal of claim 5, wherein the module unit further comprises:
a TV module for receiving broadcast content;
an MP3 module for playing an MP3 file;
a camera module for taking an image of a subject; and
a game module for executing games.

7. The terminal of claim 1, wherein the module unit comprises at least one independent hardware module.

8. A method for multitasking in a broadcast terminal, the method comprising:
checking whether a second task is selected by a user while executing a first task;
deactivating the first task when the second task is selected;
activating the second task;
checking whether the second task is completed; and
re-activating the first task when the second task is completed.

9. The method of claim 8, wherein the step of activating the second task comprises:
reassigning the first task from a first task group to a second task group;
deactivating the first task;
reassigning the second task to the first task group; and
activating the second task.

10. The method of claim 9, wherein the first task group comprises the activated task.

11. The method of claim 9, wherein the second task group comprises the deactivated task.

12. The method of claim 9, wherein the step of re-activating the first task comprises assigning the first task from the second task group to the first task group.

13. The method of claim 8, wherein the first task is to provide broadcast content.

14. The method of claim 8, wherein the second task is to provide a supplementary service.

15. An apparatus for supporting digital multimedia broadcasting, the apparatus comprising:
a module unit for storing instructions used to perform multiple tasks;
a multitask unit for managing the multiple tasks to be performed; and
a controller cooperating with the module unit and the multitask unit for executing a first task and detecting whether a second task is selected while the first task is being executed, deactivating the first task when the second task is selected, activating the second task, and re-activating the first task when the second task is completed.

16. The apparatus of claim 15, further comprising a plurality of output means, each of the output means providing one of audible, visual, and tactile outputs.

17. The apparatus of claim 16, wherein the controller selectively deactivates and the first task and activates the second task when the second task uses the same output means as the first task.

18. The apparatus of claim 16, wherein the controller activates both the first and second tasks when the second task uses a different output means than the first task.

19. The apparatus of claim 15, wherein the first task is an image reproduction function and the second task is a short messaging service function.

20. The apparatus of claim 19, wherein an audio reproduction function is executed while the short messaging service function is executed.
